(19) United States
(12) Patent Application Publication
(10) Pub. No.: US 2024/0203612 A1
(43) Pub. Date: Jun. 20, 2024

(54) Overlapping Twisted Fuel Rods

(71) Applicant: Gabriel Steven Schneck, East Lyme, CT (US)

(72) Inventor: Gabriel Steven Schneck, East Lyme, CT (US)

(21) Appl. No.: 18/398,548

(22) Filed: Dec. 28, 2023

Related U.S. Application Data
(60) Provisional application No. 63/478,110, filed on Dec. 30, 2022.

(51) Int. Cl. G21C 3/32

(52) U.S. Cl. CPC G21C 3/32

(57) ABSTRACT

Provided are twisted fuel rod bundles arranged in a pattern that allows for the twisted fuel rod circumferential cross sections to overlap which increases power density, minimizes volume, increase heat transfer characteristics and provides for more structural support.

### CROSS-REFERENCE TO RELATED APPLICATIONS

This application claims the benefit of U.S. Provisional Patent Application No 63/478,110 filed Dec. 30, 2022, which is incorporated by reference herein in its entirety.

### FIELD OF INVENTION

Embodiments of the present invention relate generally to fuel bundles for nuclear fission energy and more particularly to embodiments providing a plurality of bundled of twisted fission rods whose circumferential cross sections overlap.

### BACKGROUND OF THE INVENTION

Lightbridge Corporation is developing twisted fuel rod technology. The rods that Lightbridge uses are twisted rods that are either a tri-lobed or quad-lobed shaped. As defined in US 2016/0035411A published Feb. 4, 2016, Lightbridge aligns their fuel rods so that the circumferential cross sections do not overlap as indicated in FIG. 1. This invention describe in this non-provisional patent application is an improvement over this design because it aligns the rods in a more compact arrangement by allowing the circumferential cross sections to overlap to achieve a more desirable spacing, which can increase the power density of the fuel bundle. Allowing the circumferential cross sections of the individual fuel rods to overlap can also allow for better heat transfer characteristics, and can minimize shell side volume while also allowing for more structural support. This circumferential cross section overlap is an improvement over the current design.

### BRIEF SUMMARY OF INVENTION

In one embodiment of the present invention, a novel nuclear fuel rod bundle arrangement is provided that places the fuel rods adjacent to each other such that their circumferential cross sections overlap.

### BRIEF DESCRIPTION OF THE SEVERAL VIEWS OF THE FIGURE

FIG. 1 shows a drawing from Lightbridge patent describing a cross section of fuel elements.

FIG. 2 shows various n-lobed fuel rod shapes that can potentially be used and their corresponding cross sections.

FIG. 3a1 shows tri lobed fuel rods that do not overlapped.

FIG. 3a2 shows the circumferential cross sections of tri lobed fuel rods that do not overlapped.

FIG. 3a3 shows tri lobed fuel rods whose circumferential cross sections are no overlapped.

FIG. 3a4 shows the cross sections of tri lobed fuel rods whose circumferential cross sections are overlapped.

FIG. 4a shows bi-lobed fuel rods whose circumferential cross sections do not overlap.

FIG. 4b shows that when one rod is twisted with respect to an adjacent rod, a gap is formed.

FIG. 4c shows the rods in FIG. 4b can be pushed together such that their circumferential cross sections overlap.

FIG. 5 shows the circumferential cross section of quad-lobed rods whose circumferential cross sections overlap.

FIG. 6 shows the circumferential cross section of quad-lobed and bi-lobed rods whose circumferential cross sections overlap and form a square pitch pattern.

FIG. 7 shows a cross section of tri-lobed and bi-lobed tubes whose circumferential cross sections overlap while arranged in a triangular pitched pattern.

NOTE: Quad-lobed tubes can also be arranged in a triangular pitch whose circumferential cross sections can overlap.

FIG. 8 shows various n-lobed rods that can be arranged in a square pitch such that their circumferential cross sections overlap.

FIG. 9 shows various n-lobed rods that can be arranged in a triangular pitch such that their circumferential cross sections overlap.

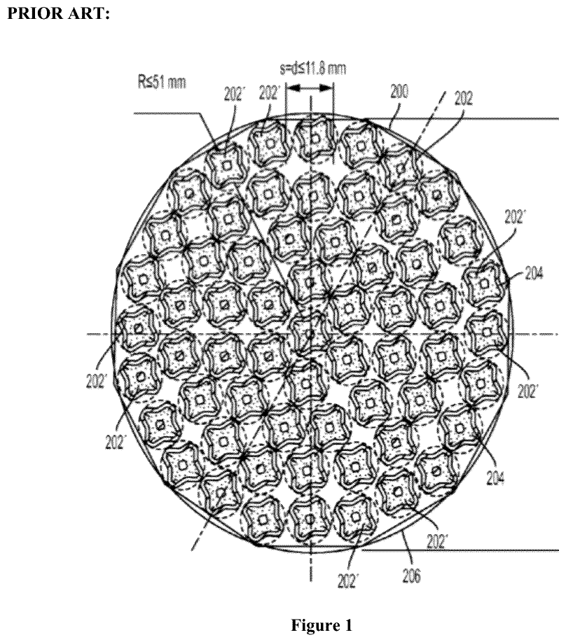

### DETAILED DESCRIPTION OF THE INVENTION

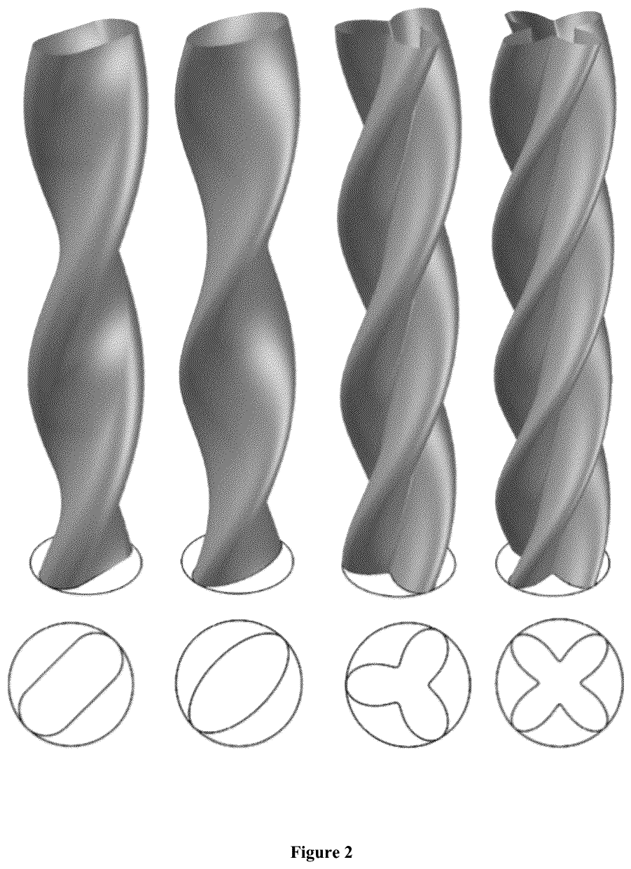

The following discussion describes how the circumferential cross sections for adjacent fuel elements in a bundle can overlap to make the fuel bundle more compact as it relates to bi-lobed (2 lobes) , tri-lobed (3 lobes) , and quad-lobed (4 lobes) fuel rods as seen in FIG. 2. Even though this discussion is limited to 2-4 lobed tubes, the improvement can work for any number of lobes. For the purposes of this discussion, the circumferencial cross section for a single rod is defined by the circle that can be circumscribed around tube as well as the shape of the tube itself inside the circle as can be seen in the circumferencial cross section views in FIG. 2.

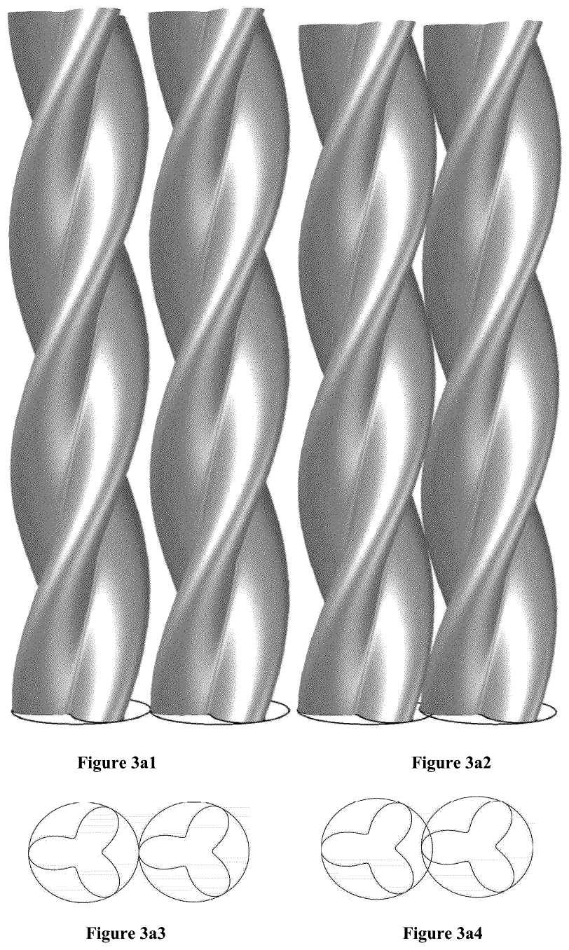

FIGS. 3a1, 3a2, 3a3, 3a4 demonstrate that, when appropriately arranged, trilobed rods can be pushed closer together. A gap between rods can be seen when looking at the arrangement between the rods in FIG. 3a1 and FIG. 3a2. In order for them to touch, the rods need to be pushed together as seen in FIG. 3a3 and FIG. 3a4 resulting in their circumferencial cross sections overlapping.

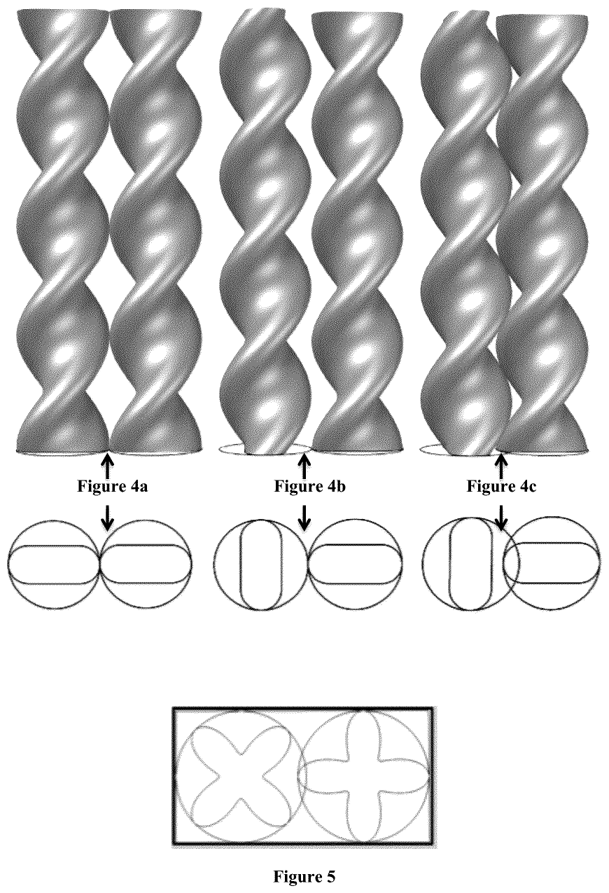

FIGS. 4a, 4b and 4c extend the above argument to bi-lobed rods. FIG. 4a shows bi-lobed fuel rods whose circumferential cross sections do not overlap. However, when one rod is rotated with respect to an adjacent rod as shown in FIG. 4b, a gap is formed. To close this gap, the rods must be pushed together as shown in FIG. 4c. When this occurs, their circumferential cross sections overlap.

FIG. 5 extends the above arguments to quad lobed rods. FIG. 5 shows the circumferential cross section of quad lobed tubes that overlap.

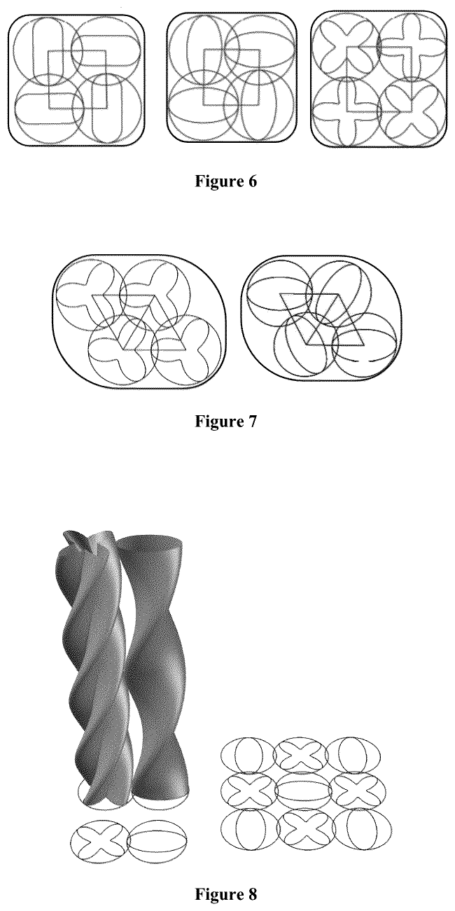

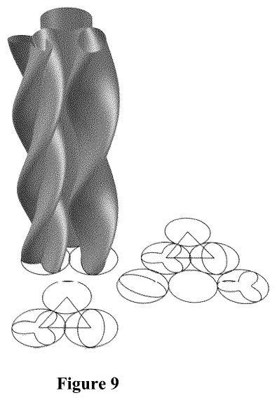

FIG. 6 extends the circumferential cross section overlapping argument and shows that bi-lobed and quad-lobed rods can be arranged in square pitch pattern while their circumferential cross sections overlap.

1. A fuel assembly for us in a core of a nuclear power reactor, the assembly comprising;
a frame shaped and configured to fit within the nuclear reactor internal core structures;
and a plurality of helically twisted fuel elements supported by the frame in a fuel rod bundle wherein the circumferential cross sections of the twisted fuel rods circumferentially overlap, each of the fuel elements comprising fissile and/or fertile material; wherein as viewed in a cross-section that is perpendicular to an axial direction of the fuel assembly, the outermost fuel elements of the fuel rod bundle define a substantially circular perimeter.
